(19) United States
(12) Patent Application Publication
(10) Pub. No.: US 2015/0095046 A1
(43) Pub. Date: Apr. 2, 2015

(54) SYSTEMS AND METHODS FOR MITIGATING RISK OF A HEALTH PLAN MEMBER

(71) Applicant: Aetna, Inc., Hartford, CT (US)

(72) Inventors: Marc J. Pironti, Lansdale, PA (US); Bonnie K. Smith, Royersford, PA (US); Pamela Broadway, Doylestown, PA (US); Daniel Greden, West Hartford, CT (US); Steve Emanuel, Colchester, CT (US); Kyra Jessene Bobinet, Walnut Creek, CA (US)

(73) Assignee: Aetna, Inc., Hartford, CT (US)

(21) Appl. No.: 14/042,450

(22) Filed: Sep. 30, 2013

(51) Int. Cl. G06F 19/00

(52) U.S. Cl. CPC G06F 19/3431
USPC 705/2

(57) ABSTRACT

A method for attempting to mitigate risk of a health plan member. The method includes: receiving medical data related to the health plan member; computing a first score for the health plan member corresponding to predicated future financial health care costs for the health plan member based on the medical data; computing a second score for the health plan member corresponding to a clinical risk for the health plan member based on the medical data; computing a third score for the health plan member corresponding to a probability of a future acute care event for the health plan member within a threshold amount of time based on the medical data; assigning the health plan member to a risk tier based on the first, second, and third scores; and engaging the health plan member based on the risk tier and one or more engagement factors.

### FIELD

This disclosure relates generally to the field of health care management and, more specifically, to a systems and methods for mitigating risk of a health plan member.

### BACKGROUND

A typical health care system includes a variety of participants, including doctors, hospitals, insurance carriers, and patients, among others. These participants frequently rely on each other for the information necessary to perform their respective roles because individual care is delivered and paid for in numerous locations by individuals and organizations that are typically unrelated. As a result, a plethora of health care information storage and retrieval systems are required to support the heavy flow of information between these participants related to patient care. Critical patient data is stored across many different locations using legacy mainframe and client-server systems that may be incompatible and/or may store information in non-standardized formats. To ensure proper patient diagnosis and treatment, health care providers often request patient information by phone or fax from hospitals, laboratories, or other providers. Therefore, disparate systems and information delivery procedures maintained by a number of independent health care system constituents lead to gaps in timely delivery of critical information and compromise the overall quality of clinical care. Since a typical health care practice is concentrated within a given specialty, an average patient may be using services of a number of different specialists, each potentially having only a partial view of the patient's medical status.

One of the participants in a typical health care system is an insurance carrier. An insurance carrier can offer a variety of health plans to its customers, which can be individuals, corporate entities, or other organizations. The customer of the insurance carrier pays a fee to the insurance carrier periodically as a hedge against the risk of incurring future medical expenses. In some instances, insurance carriers can minimize the amount of future outlays for medical expenses to its customers via active patient management. In other words, it is in the best interests of the insurance carrier (and also the member) to be as healthy as possible so as to decrease future medical expenses.

However, current approaches to active patient management are not very effective. First of all, certain health risks, such as chronic conditions, may be difficult for the insurance carrier to detect and attempt to actively manage. With chronic conditions, for example, the member's health degrades over time and thus the chronic condition may not be readily detected by the insurance carrier. Even if the chronic condition is detected and the insurance carrier attempts to engage with the member, the member may “feel fine” and may not be willing to engage with the insurance carrier for health care management. For these reasons, among others, current approaches to active patient management have low engagement rates and therefore low efficacy.

Accordingly, there remains a need in the art for systems and methods for mitigating risk of a health plan member that overcome the drawbacks and limitations of current approaches.

### SUMMARY

Some embodiments of the disclosure provide systems and methods for attempting to mitigate risk of a health plan member. The method includes: receiving medical data related to the health plan member; computing a first score for the health plan member corresponding to predicated future financial health care costs for the health plan member based on the medical data; computing a second score for the health plan member corresponding to a clinical risk for the health plan member based on the medical data; computing a third score for the health plan member corresponding to a probability of a future acute care event for the health plan member within a threshold amount of time based on the medical data; assigning the health plan member to a risk tier based on the first, second, and third scores; and engaging the health plan member based on the risk tier and one or more engagement factors.

### BRIEF DESCRIPTION OF THE DRAWINGS

FIG. 1 is a conceptual diagram of a system with reference to an overall healthcare environment, according to one embodiment.

FIG. 2 is a schematic diagram illustrating an overview of a system for mitigating risk of a health plan member, according to one embodiment.

FIG. 3 is a conceptual diagram of a predictive model for categorizing patients in an effort to mitigate risk, according to one embodiment.

FIG. 4 is a conceptual diagram illustrating a system for categorizing patients in an effort to mitigate risk, according to one embodiment.

FIG. 5 is a flow diagram illustrating a method 500 for mitigating risk of a health plan member, in accordance with an embodiment of the disclosure.

FIG. 6 is a flow diagram of assigning the health plan member to a risk tier based on first, second, and third scores, according to one embodiment.

FIG. 7 is a flow diagram of method steps illustrating different engagement types based on risk tier, according to one embodiment.

FIG. 8 is a flow diagram of method steps for engaging with a member based on risk tier and one or more engagement factors, according to one embodiment.

FIG. 9 is a conceptual diagram illustrating calculating a priority of member within a particular risk tier, according to one embodiment.

### DETAILED DESCRIPTION

Embodiments of the disclosure provide a system and method for mitigating risk of a health plan member. Various embodiments of the disclosure combine case management (i.e., for acute afflictions) and disease management (i.e., for chronic afflictions). Embodiments of the disclosure provide a more efficient and accurate way to deploy health practitioners (e.g., nurses) to health plan members in a meaningful way and to engage them in the mitigation of risks flagged by the system. The system includes novel methods to identify members in a population, stratify the members according to risk, and then determine an appropriate and cost effective communications medium through which to engage the members. In addition, embodiments of the disclosure take into consideration prior engagement attempts with the member, the results of those engagements, and a “readiness” of the member to engage with the health care system when determining if, when, and how to attempt to engage the member. As such, some embodiments of the disclosure provide for better efficacy in proactive patient management initiatives.

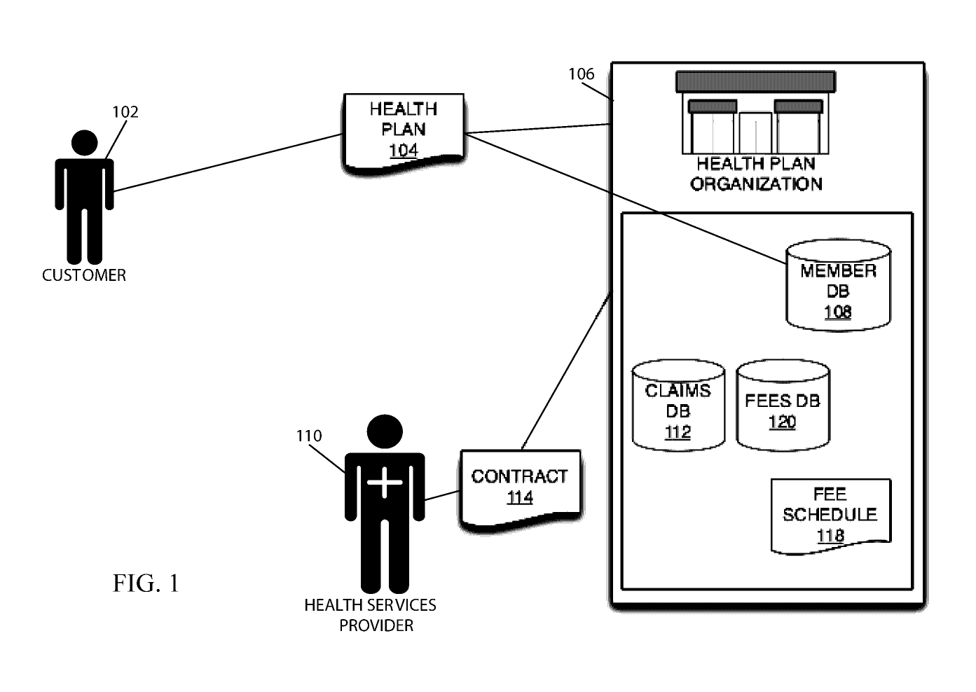

Turning to FIG. 1, an implementation of a system contemplated by an embodiment of the disclosure is shown with reference to an overall healthcare environment, according to one embodiment. A consumer (also referred to as a “subscriber” or “member” or “patient”) 102 is a member of a health plan 104 of a health plan organization (“HPO”) 106. The member 102 may subscribe to the health plan 104 through, for example, his or her employer. Alternatively, the member 102 may obtain benefits of the health plan 104 through a subscriber (e.g., a spouse or child of a subscriber can be a member of a health plan). The HPO 106 can be a health insurance company and the health plan 104 can be one of a number of health insurance or related products, such as a PPO (Preferred Provider Organization), HMO (Health Maintenance Organization), POS (Point-of-Service), or the like. The health plan 104 can also be a consumer-directed health plan, such as a high deductible health plan, health reimbursement arrangement (HRA), health savings account (HSA), or the like. The member's 102 health plan 104 covers various health care services according to one of a variety of pre-arranged terms. Details for the member 102 and the corresponding plan 104 are stored in a member database 108. The terms of the plan 104 can vary greatly from plan to plan according to: what types of services are provided, where the services are provided, by whom they are provided, the extent to which the patient is personally responsible for payment, amount of deductibles, etc. Generally, however, regardless of the specific plan subscribed to, when a member 102 obtains health care services from a provider 110, either the patient 102 or the provider 110 can submit a claim to the HPO 106 for reimbursement or payment. For analysis purposes, historical claim data is stored in a claims database 112.

A health care services provider 110 may have a contractual relationship 114 with the HPO 106. Under the contract 114, the provider 110 typically agrees to provide services to members 102 of the HPO 106 at scheduled rates. The rates are stored in a fee schedule 118, preferably stored in a fees database 120 maintained by the HPO 106. By contracting with the HPO 106, the provider 110 generally increases the amount of business the provider 110 receives from members 102, and members 102 generally receive a less expensive rate than they would otherwise receive for a health service provided by the provider 110. The actual amount of out-of-pocket expense to be paid by a member 102 may vary according to the terms of his health plan 104 (e.g., co-payments, co-insurance or deductibles may apply), but will generally be at most the contracted rate.

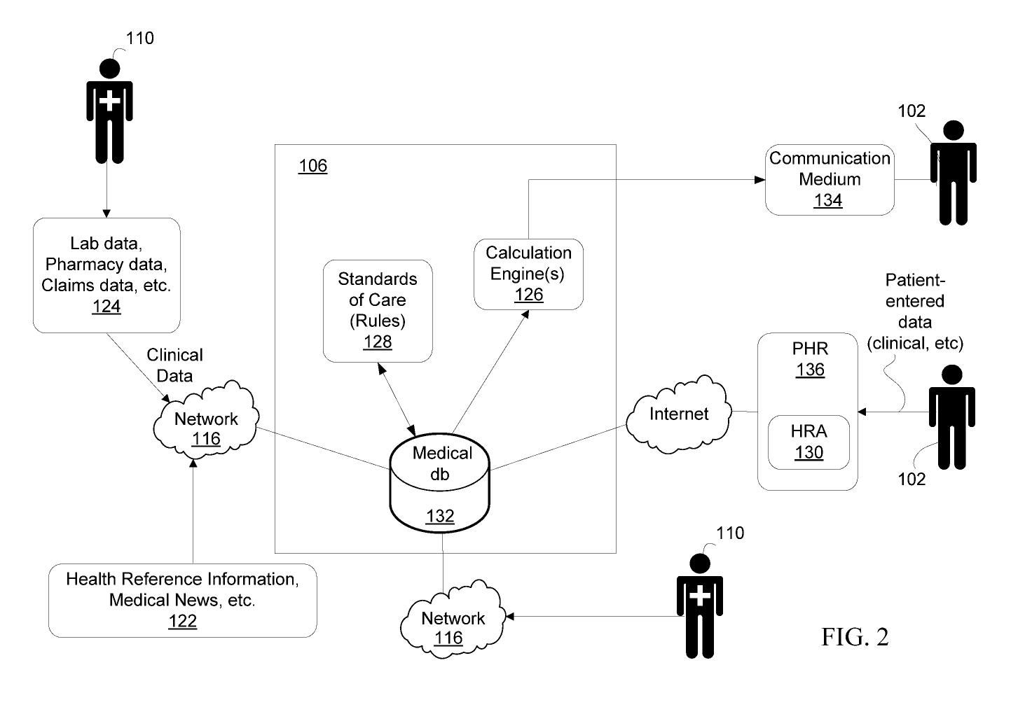

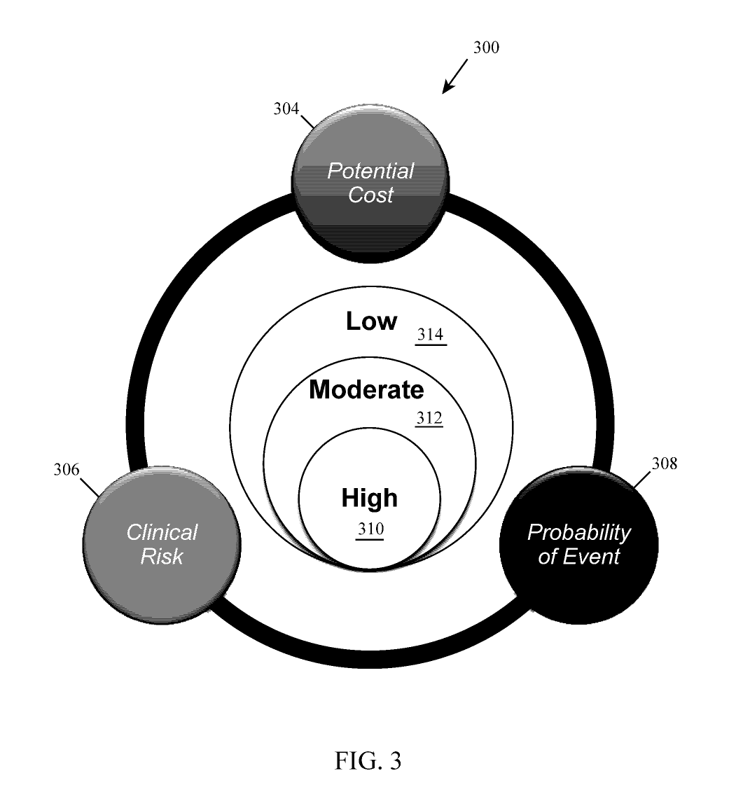

FIG. 2 is a schematic diagram illustrating an overview of a system for mitigating risk of a health plan member, according to one embodiment. A health plan organization 106 collects and processes a wide spectrum of medical care information relating to a patient 102 in order to attempt to mitigate risk of the patient 102. A personal health record (PHR) 136 of a patient 102 may be configured to solicit the patient's input for entering additional pertinent medical information, tracking follow-up actions, and allowing the health plan organization 106 to track the patient's medical history. In some embodiments, the medical care information relating to the patient can include health risk assessment (HRA) information, also referred to as a health risk appraisal, or health and well-being assessment. In one embodiment, the HRA is a questionnaire used to gather the pertinent medical information from the patient 102.

When the patient 102 utilizes the services of one or more health care providers 110, a medical insurance carrier collects the associated clinical data 124 in order to administer the health insurance coverage for the patient 102. Additionally, a health care provider 110, such as a physician or nurse, can enter clinical data 124 into one or more health care provider applications pursuant to a patient-health care provider interaction during an office visit or a disease management interaction. Clinical data 124 originates from medical services claims, pharmacy data, as well as from lab results, and includes information associated with the patient-health care provider interaction, including information related to the patient's diagnosis and treatment, medical procedures, drug prescription information, in-patient information, and health care provider notes, among other things. The medical insurance carrier and the health care provider 110, in turn, provide the clinical data 124 to the health plan organization 106, via one or more networks 116, for storage in one or more medical databases 132. The medical databases 132 are administered by one or more server-based computers associated with the health plan organization 106 and comprise one or more medical data files located on a computer-readable medium, such as a hard disk drive, a CD-ROM, a tape drive, or the like. The medical databases 132 may include a commercially available database software application capable of interfacing with other applications, running on the same or different server based computer, via a structured query language (SQL). In an embodiment, the network 116 is a dedicated medical records network. Alternatively, or in addition, the network 116 includes an Internet connection that comprises all or part of the network.

In some embodiments, an on-staff team of medical professionals within the health plan organization 106 consults various sources of health reference information 122, including evidence-based preventive health data, to establish and continuously or periodically revise a set of clinical rules 128 that reflect best evidenced-based medical standards of care for a plurality of conditions. The clinical rules 128 are stored in the medical database 132.

To supplement the clinical data 124 received from the insurance carrier, the PHR 136 and/or an HRA questionnaire allow patient entry of additional pertinent medical information that is likely to be within the realm of patient's knowledge. Examples of patient-entered data include additional clinical data, such as patient's family history, use of non-prescription drugs, known allergies, unreported and/or untreated conditions (e.g., chronic low back pain, migraines, etc.), as well as results of self-administered medical tests (e.g., periodic blood pressure and/or blood sugar readings). Preferably, the PHR 136 facilitates the patient's task of creating a complete health record by automatically populating the data fields corresponding to the information derived from the medical claims, pharmacy data, and lab result-based clinical data 124. In one embodiment, patient-entered data also includes non-clinical data, such as upcoming doctor's appointments. In some embodiments, the PHR 136 gathers at least some of the patient-entered data via a health risk assessment tool (HRA) 130 that requests information regarding lifestyle, behaviors, family history, known chronic conditions (e.g., chronic back pain, migraines, etc.), and other medical data, to flag individuals at risk for one or more predetermined medical conditions (e.g., cancer, heart disease, diabetes, risk of stroke, etc.) pursuant to the processing by a calculation engine 126. Preferably, the HRA 130 presents the patient 102 with questions that are relevant to his or her medical history and currently presented conditions. The risk assessment logic branches dynamically to relevant and/or critical questions, thereby saving the patient time and providing targeted results. The data entered by the patient 102 into the HRA 130 also populates the corresponding data fields within other areas of PHR 136. The health plan organization 106 aggregates the clinical data 124 and the patient-entered data, as well as the health reference and medical news information 122, into the medical database(s) 132 for subsequent processing via the calculation engine 126.

The health plan organization 106 includes a multi-dimensional analytical software application including a calculation engine 126 comprising computer-readable instructions for performing statistical analysis on the contents of the medical databases 132 in order to attempt to mitigate risk of the patient 102. In some embodiments, a patient is stratified into one of three risk tiers, including a high risk tier, a moderate risk tier, and a low risk tier. Based on the risk tier of a patient and other “engagement factors,” as described in greater detail herein, the health plan organization can reach out to the patient 102 via communications medium 134. Example communications media 134 include telephone, postal mail, email, text message, or other electronic or non-electronic communication media. In various embodiments, the type of communication medium 134 used to reach out to or “engage” the patient 102 depends on the risk tier and/or other engagement factors, as described in greater detail herein.

While the entity relationships described above are representative, those skilled in the art will realize that alternate arrangements are possible. In one embodiment, for example, the health plan organization 106 and the medical insurance carrier are the same entity. Alternatively, the health plan organization 106 is an independent service provider engaged in collecting, aggregating, and processing medical care data from a plurality of sources to provide a personal health record (PHR) service for one or more medical insurance carriers. In yet another embodiment, the health plan organization 106 provides PHR services to one or more employers by collecting data from one or more medical insurance carriers.

FIG. 3 is a conceptual diagram of a predictive model 300 for categorizing patients in an effort to mitigate risk, according to one embodiment. The predictive model 300 includes three primary factors, including: a first score 304 corresponding to future financial health care costs for a health plan member based on certain clinical data, a second score 306 corresponding to a clinical risk for the health plan member based on the clinical data, and a third score 308 corresponding to a probability of an avoidable future acute care event for the health plan member within a threshold amount of time based on the clinical data. In one embodiment, the future acute care event comprises being admitted to a hospital (e.g., within the next 9 months). The three scores 304, 306, 308 can be aggregated to stratify the health plan member into one of three risk tiers: a high risk tier 310, a moderate risk tier 312, and a low risk tier 314. Depending on which tier a health plan member is associated with, a different mode of engagement can be used to contact the member in an effort to mitigate the risk of the member.

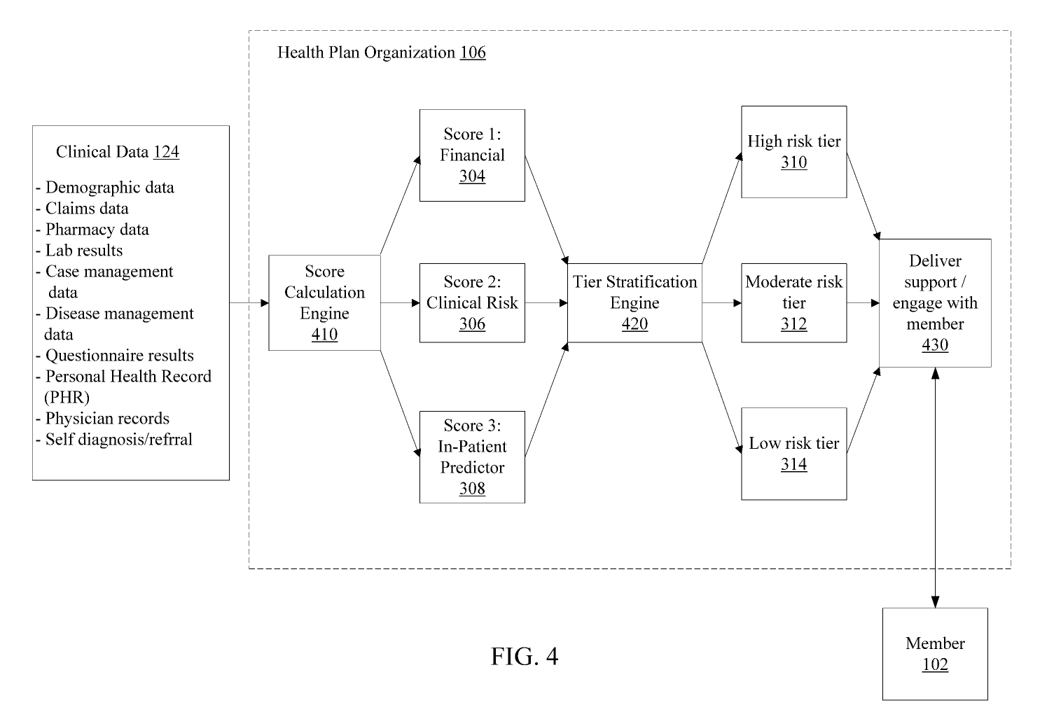

FIG. 4 is a conceptual diagram illustrating a system for categorizing patients in an effort to mitigate risk, according to one embodiment. As shown, clinical data 124 is received by a health plan organization 106 and is stored in one or more databases. The clinical data can include, among other things: demographic data, claims data, pharmacy data, lab results, case management data, disease management data, questionnaire results, a personal health record (PHR) of the member, physician records, member self-reported data, etc. Examples of demographic data include: age, gender, member type (e.g., subscriber, spouse, child), family status (e.g., single, married, married with children, single with children), region of residence, (United States Postal Service) USPS-defined rural/suburban/urban by zip code, median household income by zip code, race/ethnicity ratios by zip code (e.g., White/Caucasian, Black/African American, Hispanic, Asian, Pacific Islander, etc.), member's insurance product category, or any other additional information (e.g., dental records, mental health records, substance abuse records, etc.).

In one embodiment, a questionnaire is provided to a member that includes questions directed to behavioral data as well as clinical data. In one embodiment, behavioral data is associated with the member's personal circumstances in the real-world, and clinical data is associated with medical information. Examples of questions related to behavioral data include: “do you have support from friends and family,” “how confident are you that you can manage your health,” questions related to depression or contemplation of suicide, etc. Questions related to clinical data can include, for example, “have you been taking your medication as prescribed?” In one embodiment, case management data includes data associated with acute afflictions, and disease management data includes data associated with chronic afflictions.

A score calculation engine 410 executed by one or more processors within one or more computing devices of the health plan organization 106 process the clinical data 124 to generate the scores 304, 306, 308. As described above, the first score 304 is a financial score that attempts to predict the future financial costs associated with medical care for the member if no intervention/engagement is made with the member. In one embodiment, the first score is calculated based predicting which conditions the member is likely to exhibit based on the clinical data 124 and the cost associated with treating those conditions. The prediction can be made based on a weighted sum of various pieces of clinical data 124.

The second score 306 is a clinical risk score that attempts to predict a clinical risk for the member if no intervention/engagement is made with the member. In one embodiment, the second score 306 is computed based on a set of clinical identification and validation rules, scoring models, and stratification algorithms. The score represents the degree to which disease management has an opportunity to impact the member's health status and clinical outcomes.

The third score 308, referred to in some embodiments as an “in-patient predictor” score, identifies a probability of an avoidable future acute care event for the health plan member within a threshold amount of time. As an example, the third score may predict the likelihood that the member will be admitted to a hospital within the next 9 months. Other examples include whether the member is expected to have a high-cost claim within the threshold amount of time, or if the member is at a suicide risk. The third score 308 is calculated based on a number of conditions the member presents on a list of risk conditions and historical financial expenditures associated with treatment of the member for at least one of the conditions. In various embodiments, the threshold amount of time is configurable.

A tier stratification engine 420 executed by one or more processors within one or more computing devices of the health plan organization 106 receive the scores 304, 306, 308 and, based on the scores 304, 306, 308, categorize the member into one of three risk tiers 310 (high risk tier), 312 (moderate risk tier), 314 (low risk tier). In one embodiment, calculation engine 126 in FIG. 2 includes both the score calculation engine 410 and the tier stratification engine 420. Depending on which risk tier a member is categorized into, and also based on other engagement factors, as described in greater detail below, the health plan organization 106 attempts to engage 430 with the member 102. The other engagement factors may include, for example, a result of prior engagement attempts with the member, whether the member responded to the engagement attempt at all, whether the member expressed an unwillingness to be engaged, whether the member expressed a willingness to engage, whether the member has been engaging with the health plan organization 106 and is meeting his or her health goals, among other criteria. The engagement with the member is intended to mitigate the risk associated with the member, e.g., to reduce overall health care costs associated with the member and increase the health and well-being of the member.

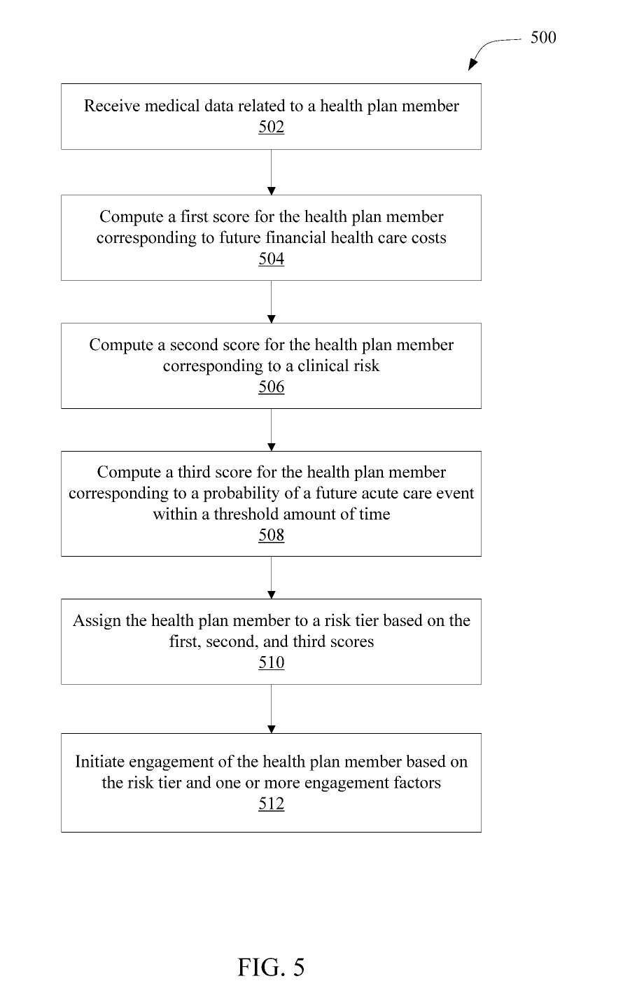

FIG. 5 is a flow diagram illustrating a method 500 for mitigating risk of a health plan member, in accordance with an embodiment of the disclosure. As shown, the method 500 begins at step 502, where a processor, such as a processor associated with the calculation engine 126, receives medical data related to the health plan member. The medical data may include the clinical data 124 described above.

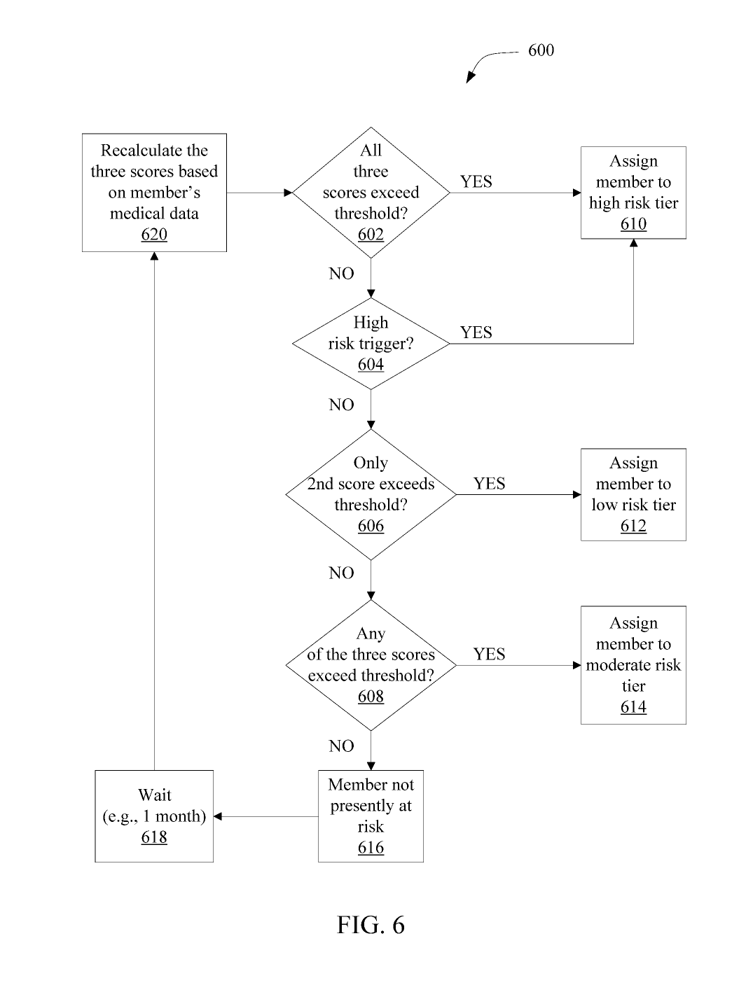

At step 504, the processor computes a first score for the health plan member corresponding to future financial health care costs for the health plan member based on the medical data. At step 506, the processor computes a second score for the health plan member corresponding to a clinical risk for the health plan member based on the medical data. At step 508, the processor computes a third score for the health plan member corresponding to a probability of a future acute care event for the health plan member within a threshold amount of time based on the medical data. At step 510, the processor assigns the health plan member to a risk tier based on the first, second, and third scores. One non-limiting example implementation for assigning the health plan member to a risk tier is described in FIG. 6.

FIG. 6 is a flow diagram of assigning the health plan member to a risk tier based on first, second, and third scores, according to one embodiment. In one embodiment, a first threshold amount, a second threshold amount, and a third threshold amount correspond to thresholds that indicate requisite risk level for each of the first, second, and third scores, respectively. According to various embodiments, the first, second, and third threshold amounts can be the same or different.

As shown, the method 600 begins at step 602, where a processor, such as a processor associated with the calculation engine 126, determines whether the first score exceeds the first threshold amount, whether the second score exceeds the second threshold amount, and whether the third score exceeds the third threshold amount. If each of the three scores exceeds the corresponding threshold amount, then the method 600 proceeds to step 610, where the processor assign the member to a high risk tier.

If, at step 602, not all of the scores exceed the corresponding threshold amount, then the method 600 proceeds to step 604, where the processor determines whether a high risk trigger is included in the medical data. If a high risk trigger is present in the medical data, then the method 600 proceeds to step 610, where the processor assign the member to a high risk tier. When a high risk trigger is present, the member is considered to be high risk, regardless of whether the first, second, or third scores exceed the corresponding threshold amounts. Examples of high risk triggers include: the member recently having a high-cost claim, the member recently being in a car accident, the member exhibiting thoughts of suicide, a recent emergency room admission, etc. These high risk triggers are intended merely to better illuminate the disclosure and do not pose a limitation on the scope of the disclosure.

If, at step 604, a high risk trigger is not included in the medical data, then the method 600 proceeds to step 606, where the processor determines whether only the second score exceeds the second threshold amount, where the first score does not exceed the first threshold amount, and the third score does not exceed the third threshold amount. If YES at step 606, then at step 612, the processor assigns the member to the low risk tier. If NO at step 606, then the method 600 proceeds to step 608, where the processor determines whether any of the first, second, or third scores exceed the first, second, or third threshold amounts, respectively. If yes, then at step 614, the processor assigns the member to the moderate risk tier.

If NO at step 608, then the method 600 proceeds to step 616, where the processor determines that the member is not presently at risk. At step 618, the processor waits for a predetermined amount of time (for example, 1 month) before recalculating the first, second, and third scores for the member with updated medical data at step 620. In some embodiments, the predetermined amount of time is configurable. The method 600 then returns to step 602, described above.

Referring again to FIG. 5, after the risk tier has been assigned at step 510, the method 500 proceeds to step 512 where the processor initiates engagement of the health plan member based on the risk tier and one or more “engagement factors.” According to various embodiments, the engagement factors can include: a prior risk tier of the member, prior engagement attempt(s), the result(s) of prior engagement attempt(s), an amount of time that has passed since the last engagement attempt, an amount of time that has passed since the last active engagement with the member, an indicator corresponding to whether the member is meeting his or her health goals, and an indicator as to which score (i.e., the first score 304, the second score 306, or the third score 308 in FIG. 4) triggered the outreach to the member, among others. The result of a prior attempt to engage the health plan member may include one of: (a) no answer from the health plan member based on the prior attempt, (b) an indication from the health plan member of an affirmative unwillingness to engage, or (c) an indication from the health plan member of a willingness to engage. Another example of “engagement factors” may include an “engagement priority” of the member relative to the other members in the same tier (described in more detail below).

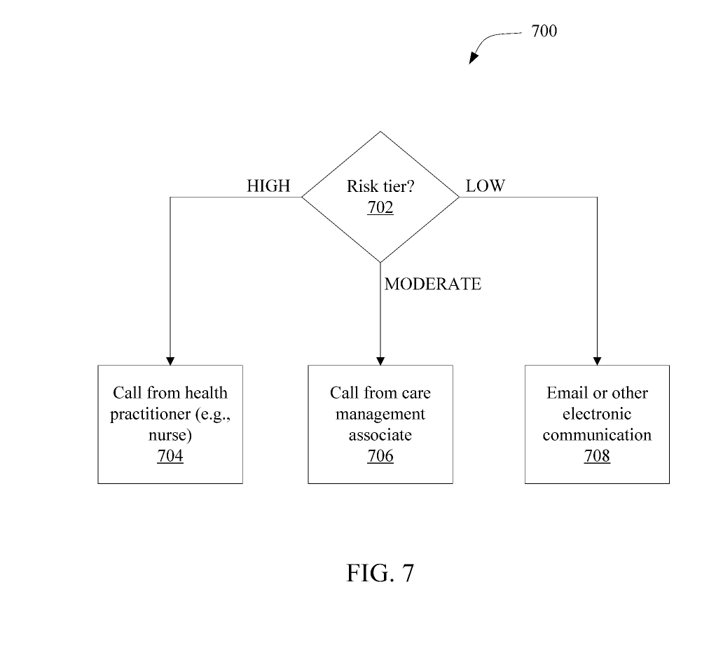

As described, the type of engagement that is initiated by the processor can depend on various factors, including the risk tier associated with the member. FIG. 7 is a flow diagram of method steps illustrating different engagement types based on risk tier, according to one embodiment. As shown, the method 700 begins at step 702, where a processor, such as a processor associated with the calculation engine 126, determines a risk tier of the member. In one embodiment, the risk tier can be determined using the method 600 in FIG. 6. As shown in FIG. 7, a different interaction is provided depending on the risk tier of the member. In the embodiment shown in FIG. 7, if the member is in the high risk tier, then at step 704, initiating the engagement comprises initiating a telephone call from a health practitioner (e.g., a nurse) to the member. If the member is in the moderate risk tier, then at step 706, initiating the engagement comprises initiating a telephone call from a care management associate to the member. In some embodiments, a care management associate (CMA) is not a nurse, but rather a staff member who is trained in both the operations of the care management program, and assists the nurses in optimizing the nurse's interactions with health plan members by coordinating processes and recording data related to the activities of the care management program. If the member is in the low risk tier, then at step 708, initiating the engagement comprises sending an email or other electronic communication to the member. Other electronic communications can include a text message or a chat message, for example. As shown and described in FIG. 7, the different resources utilized to initiate the engagement include a health practitioner or nurse (i.e., for the high risk tier), a CMA (i.e., for the moderate risk tier), and electronic communication (i.e., for the low risk tier). The different resources shown and described in FIG. 7 are merely examples, and different or other resources used to initiate the engagement are also within the scope of embodiments of the disclosure.

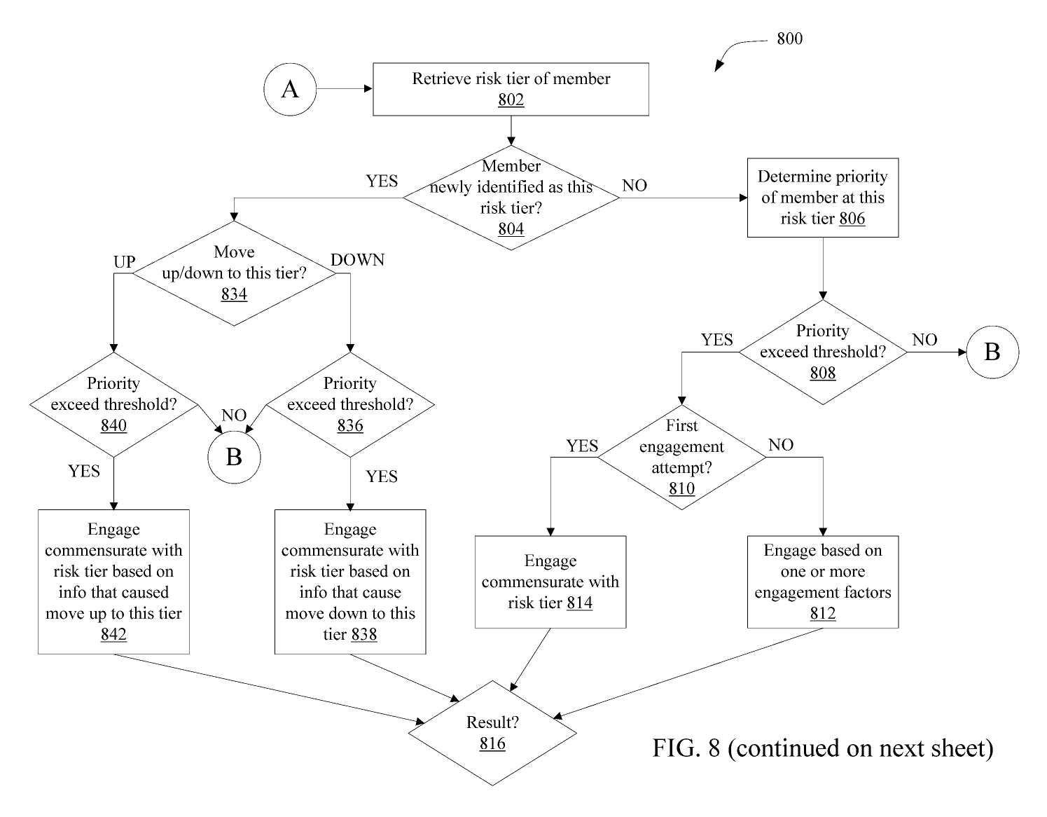

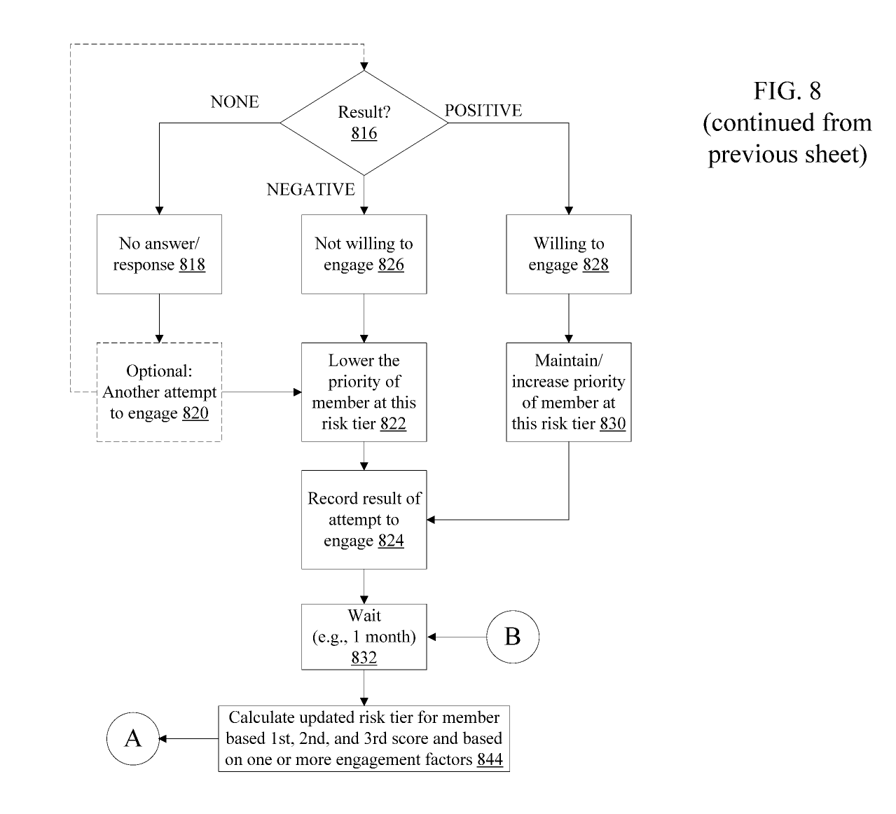

FIG. 8 is a flow diagram of method steps for engaging with a member based on risk tier and one or more engagement factors, according to one embodiment. Because of the complexity of the method, FIG. 8 spans two figure sheets.

The method 800 shown in FIG. 8 begins at step 802, where a processor, such as such as a processor associated with the calculation engine 126, retrieves a risk tier of a member. An initial setting of the risk tier may be determined using the method shown in FIG. 6 and retrieved by the processor from a memory communicatively coupled to the processor.

At step 804, the processor determines whether the member is newly identified (i.e., for the first time) at the current risk tier. In other words, the processor determines whether the member was, at any previous time, associated with the current risk tier retrieved at step 802 in a previous iteration of the method 800. If not, then the method 800 proceeds to step 806, where the processor determines a priority of the member at this risk tier. According to various embodiments, the health plan organization may not have the resources to reach out and engage with each and every member at a given risk tier. Therefore, embodiments of the disclosure provide for ranking the members within each risk tier according a priority of the member relative to the other members at the same risk tier. In that manner, the health plan organization can make most efficient use of its limited resources when attempting to engage with at-risk members.

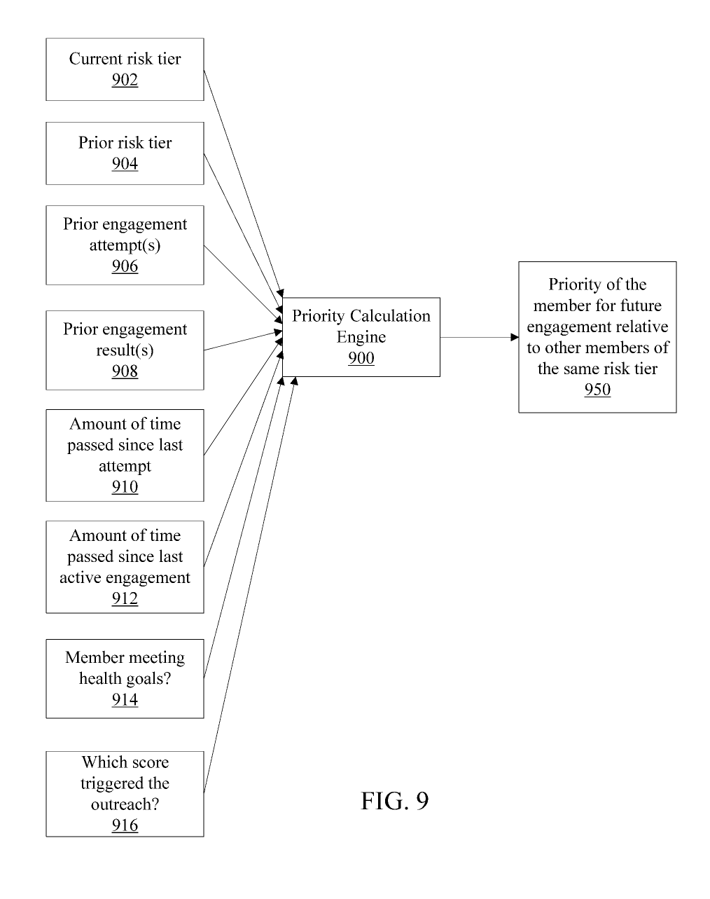

FIG. 9 is a conceptual diagram illustrating calculating a priority of member within a particular risk tier, according to one embodiment. As shown, a priority calculation engine 900 receives various pieces of information and, based on the received information, outputs a priority of the member for future engagement relative to the other members of the same risk tier (950). Example input into the priority calculation engine 900 includes one or more of: a current risk tier 902, a prior risk tier 904, prior engagement attempt(s) 906, the result(s) of prior engagement attempt(s) 908, an amount of time that has passed since the last engagement attempt 910, an amount of time that has passed since the last active engagement 912 with the member, an indicator corresponding to whether the member is meeting his or her health goals 914, and an indicator as to which score (i.e., the first score 304, the second score 306, or the third score 308 in FIG. 4) triggered the outreach to the member. In one embodiment, the priority calculation engine 900 is included as part of the calculation engine 126 in FIG. 1.

Referring again to FIG. 8, at step 808, the processor determines whether the priority corresponding to the member exceeds a threshold priority. If not, then the method 800 proceeds to step 832. At step 832, the processor waits for a predetermined amount of time, for example, 1 month. In some embodiments, the predetermined amount of time is configurable.

At step 844, after the predetermined amount of time has passed, the processor calculates an updated risk tier for the member based on the first score 304, the second score 306, and the third score 308 and also based on one or more engagement factors. In one embodiment, the engagement factors comprise the factors 902, 904, 906, 908, 910, 912, 914, 916 used by the priority calculation engine 900 to determine priority of the member within a risk tier. As such, embodiments of the disclosure provide a more intelligent approach to engaging with members, as compared to prior art techniques. In the disclosed embodiments, the decision of whether or not to engage a member, the timing for engaging a member, and the type of engagement attempted are based on one or more engagement factors, including, for example, results of prior engagements. The engagement factors correspond to a member's willingness to engage. In this manner, embodiments of the disclosure provide techniques that match the level of urgency of the member when attempting to engage the member, which leads to more active and better engagement with the member. After step 844, the method returns to step 802, described above, and another iteration of the method 800 is performed.

If, at step 808, the processor determines that the priority corresponding to the member does exceed a threshold priority, then at step 810, the processor determines whether this is the first engagement attempt with the member at this risk tier. If yes, then at step 814, the processor initiates an engagement with the member commensurate with the “standard” engagement type for the current risk tier. As described in FIG. 7, different communication mediums can be used to engage members at different risk tiers.

If, at step 810, the processor determines that this is not the first engagement attempt with the member, then at step 812, the processor initiates an engagement with the member based on one or more of the engagement factors.

If, at step 804, the processor determines that the member is newly identified (i.e., for the first time) at the current risk tier, then at step 834, the processor determines whether the member has moved up or down to this risk tier from another risk tier, where moving up corresponds to moving to a higher-risk risk tier. If the member has moved UP to this risk tier, then at step 840, the processor determines whether the priority corresponding to the member exceeds a threshold priority. If not, then the method 800 proceeds to step 832, described above. If, at step 840, the processor determines that the priority corresponding to the member does exceed a threshold priority, then at step 842, the processor initiates an engagement with the member based on, at least in part, the information or data that caused the member to move up to this risk tier.

If, at step 834, the processor determines that the member has moved DOWN to this risk tier, then at step 836, the processor determines whether the priority corresponding to the member exceeds a threshold priority. If not, then the method 800 proceeds to step 832, described above. If, at step 836, the processor determines that the priority corresponding to the member does exceed a threshold priority, then at step 838, the processor initiates an engagement with the member based on, at least in part, the information or data that caused the member to move down to this risk tier.

From each of steps 812, 814, 838, 842, the method 800 proceeds to step 816, where the processor identifies a result of the engagement attempt. If there is no answer or no response to the engagement attempt (step 818), then at step 820, the processor may optionally attempt to engage the member again. If still no answer or no response, then the method 800 proceeds to step 822, where the processor lowers a priority of the member relative to other members at this risk tier. As described, embodiments of the disclosure are intended to engage with those members that are likely to engage or are actively engaging. If a member is unresponsive or unwilling to engage, then the priority of that member is decreased in favor of attempts to engage with other members at the same risk tier.

If, at step 816, the processor determines that the member is affirmatively not willing to engage (step 826), then the method 800 proceeds to step 822, and lowers the priority of the member. If, at step 816, the processor determines that the member is affirmatively willing to engage (step 828), then the method 800 proceeds to step 830, and maintains or increases the priority of the member relative to the other members at the same risk tier. Again, since at step 828 this member is actively engaging, the system should continue engaging with this member.

At step 824, the results of the engagement attempt are recorded in a record for the member. The results of the engagement attempt may be one of the “engagement factors” used to calculate the updated risk score at step 844.

In sum, embodiments of the disclosure take into consideration prior engagement attempts with the member, the results of those engagements, and/or a “readiness” of the member to engage with the health care system when determining if, when, and how to attempt to engage the member. As such, some embodiments of the disclosure provide for better efficacy in proactive patient management initiatives.

All references, including publications, patent applications and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

One embodiment of the disclosure may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A method for attempting to mitigate risk of a health plan member, the method comprising:
receiving medical data related to the health plan member;
computing a first score for the health plan member corresponding to predicated future financial health care costs for the health plan member based on the medical data;
computing a second score for the health plan member corresponding to a clinical risk for the health plan member based on the medical data;
computing a third score for the health plan member corresponding to a probability of a future acute care event for the health plan member within a threshold amount of time based on the medical data;
assigning the health plan member to a risk tier based on the first, second, and third scores; and
engaging the health plan member based on the risk tier and one or more engagement factors.

2. The method of claim 1, wherein the one or more engagement factors include one or more of: a prior risk tier of the health plan member, a result of a prior engagement attempt with the health plan member, an amount of time that has passed since a last engagement attempt with the health plan member, and an amount of time that has passed since a last active engagement with the health plan member.

3. The method of claim 1, wherein the health plan member is assigned to a high risk tier if the first score exceeds a first threshold score, the second score exceeds a second threshold score, and the third score exceeds a third threshold score.

4. The method of claim 3, wherein the health plan member is assigned the high risk tier if the medical data includes triggering data, regardless of whether the first, second, and third scores exceed the first, second, and third threshold scores, respectively.

5. The method of claim 4, wherein the health plan member is assigned to a low risk tier if the second score exceeds the second threshold score, but the first score does not exceed the first threshold score and the third score does not exceed the third threshold score.

6. The method of claim 5, wherein, if the health plan member is not assigned to the low risk tier, then the health plan member is assigned to a moderate risk tier if the first score exceeds first threshold score, the second score exceeds the second threshold score, or the third score exceeds the third threshold score.

7. The method of claim 6, wherein:
if the health plan member is assigned to the high risk tier, then engaging the health plan member comprises initiating a telephone call to be placed from a health practitioner to the health plan member;
if the health plan member is assigned to the moderate risk tier, then engaging the health plan member comprises initiating a telephone call to be placed from a care management associate to the health plan member; and
if the health plan member is assigned to the low risk tier, then engaging the health plan member comprises sending an email or other electronic communication to the health plan member.

8. The method of claim 1, wherein medical data comprises results of a questionnaire answered by the health plan member.

9. The method of claim 1, further comprising:
evaluating a priority of the health plan member within the risk tier prior; and
engaging the health plan member when the priority of the health plan member exceeds a priority threshold amount.

10. The method of claim 1, wherein the one or more engagement factors include a result of a prior attempt to engage the health plan member, which includes one of:
(a) receiving no answer from the health plan member based on the prior attempt;
(b) receiving an indication from the health plan member of an affirmative unwillingness to engage; or
(c) receiving an indication from the health plan member of a willingness to engage.

11. The method of claim 10, further comprising:
if the result of the prior attempt to engage the health plan member is (a) receiving no answer from the health plan member based on the prior attempt, or (b) receiving an indication from the health plan member of an affirmative unwillingness to engage, then waiting a threshold amount of time before attempting to engage the health plan member again.

12. A system, comprising:
a clinical data database; and
a healthcare organization computing device executing one or more processors to attempt to mitigating risk of a health plan member, by performing the steps of:
receiving medical data related to the health plan member that is stored in the clinical data database;
computing a first score for the health plan member corresponding to predicated future financial health care costs for the health plan member based on the medical data;
computing a second score for the health plan member corresponding to a clinical risk for the health plan member based on the medical data;
computing a third score for the health plan member corresponding to a probability of a future acute care event for the health plan member within a threshold amount of time based on the medical data;
assigning the health plan member to a risk tier based on the first, second, and third scores; and
engaging the health plan member based on the risk tier and one or more engagement factors.

13. The system of claim 12, wherein the one or more engagement factors include one or more of: a prior risk tier of the health plan member, a result of a prior engagement attempt with the health plan member, an amount of time that has passed since a last engagement attempt with the health plan member, and an amount of time that has passed since a last active engagement with the health plan member.

14. The system of claim 12, wherein the health plan member is assigned to a high risk tier if the first score exceeds a first threshold score, the second score exceeds a second threshold score, and the third score exceeds a third threshold score.

15. The system of claim 14, wherein the health plan member is assigned the high risk tier if the medical data includes triggering data, regardless of whether the first, second, and third scores exceed the first, second, and third threshold scores, respectively.

16. The system of claim 15, wherein the health plan member is assigned to a low risk tier if the second score exceeds the second threshold score, but the first score does not exceed the first threshold score and the third score does not exceed the third threshold score.

17. The system of claim 16, wherein, if the health plan member is not assigned to the low risk tier, then the health plan member is assigned to a moderate risk tier if the first score exceeds first threshold score, the second score exceeds the second threshold score, or the third score exceeds the third threshold score.

18. The system of claim 17, wherein:
if the health plan member is assigned to the high risk tier, then engaging the health plan member comprises initiating a telephone call to be placed from a health practitioner to the health plan member;
if the health plan member is assigned to the moderate risk tier, then engaging the health plan member comprises initiating a telephone call to be placed from a care management associate to the health plan member; and
if the health plan member is assigned to the low risk tier, then engaging the health plan member comprises sending an email or other electronic communication to the health plan member.

19. The system of claim 12, wherein the one or more engagement factors include a result of a prior attempt to engage the health plan member, which includes one of:
(a) receiving no answer from the health plan member based on the prior attempt;
(b) receiving an indication from the health plan member of an affirmative unwillingness to engage; or
(c) receiving an indication from the health plan member of a willingness to engage.

20. The system of claim 19, wherein the healthcare organization computing device is further configured to:
wait a threshold amount of time before attempting to engage the health plan member again if the result of the prior attempt to engage the health plan member is (a) receiving no answer from the health plan member based on the prior attempt, or (b) receiving an indication from the health plan member of an affirmative unwillingness to engage.
